(19) United States
(12) Patent Application Publication
(10) Pub. No.: US 2019/0024640 A1
(43) Pub. Date: Jan. 24, 2019

(54) Air-Cooled Oil Tank, and Wind Turbine Comprising an Air-Cooled Oil Tank

(71) Applicant: Aerodyn Consulting Singapore pte ltd, Singapore (SG)

(72) Inventor: Sonke SIEGFRIEDSEN, Rendsburg (DE)

(21) Appl. No.: 15/774,367

(22) PCT Filed: Sep. 19, 2016
(86) PCT No.: PCT/DE2016/100437

§ 371 Date: May 8, 2018

(30) Foreign Application Priority Data
Nov. 30, 2015 (DE) 10 2015 120 706.0

(51) Int. Cl. F03D 80/60; F03D 80/70

(52) U.S. Cl. CPC F03D 80/60; F01M 2011/0025; F03D 80/70

(57) ABSTRACT

Air-cooled oil tank comprising a plurality of pipes which are designed to conduct cooling air therethrough, have substantially the same diameter and extend through the oil tank, characterized by a second pipe which is designed to conduct cooling air therethrough and extends through the oil tank and within the diameter of which a fan is arranged, the diameter of the second pipe being greater than the diameter of the first pipes.

The invention relates to an air-cooled oil tank with a multiplicity of pipelines, which permeate the oil tank and are designed for conducting cooling air, having an essentially identical diameter. The invention also relates to a wind energy system with an air-cooled oil tank.

An initially described air-cooled oil tank is, for example, known from KR 20060022570 A. This known oil tank is designed particularly for receiving hydraulic oil, wherein the hydraulic oil is cooled such that cooling air is pressed into the pipelines, which permeate the oil tank in a longitudinal direction, by a fan arranged outside of the tank.

When compared to water-cooled hydraulic oil tanks, KR 20060022570 A determines that it is advantageous that a heat exchanger for the water circuit and the risk of a contamination of the water circuit is omitted. Therefore, an air-cooled oil tank is less elaborate and easier to manufacture with regard to its safety and damage susceptibility.

Due to the last-named deliberations, the air-cooling of lubricating and hydraulic oil is preferably also used in wind energy systems. For example, US 2011/0272949 A1 shows a wind energy system with a closed oil circuit formed between an oil tank and a heat exchanger, wherein the heat exchanger, which is not specified in detail, is introduced and air-cooled in an open cooling-air circuit.

A different air-cooled wind energy system, for example, is disclosed in EP 2 163 761 A1. A further heat exchanger, for example, is known from US2012/0006524 A 1.

It is basically conceivable that the air-cooled oil tank known from KR 20060022570, which dispenses with an additional heat exchanger, can be used in wind energy systems. However, due to the restrictions imposed by the layout of the individual components of the wind energy system, particularly the requirements for a compact structure, an installation of the known oil tank would be too space-consuming.

Therefore, the problem addressed by the invention is that of creating an air-cooled oil tank, particularly an air-cooled oil tank suitable for wind energy systems, which is designed so as to be particularly space-saving.

According to the invention, this problem is solved by the air-cooled oil tank with the features of claim 1 and the wind energy system with the features of claim 6. The dependent claims each disclose advantageous embodiments of the invention.

The basic idea of the invention is that of designing an air-cooled oil tank such that the air flowing through the oil tank can be used not only for cooling the oil stored in the oil tank but also for cooling components which are arranged outside of the oil tank or independently from the oil tank.

According to the invention, an air-cooled oil tank with a multiplicity of first pipelines, which permeate the oil tank and are designed for conducting cooling air, having an essentially identical diameter, is thus provided, wherein a second pipeline is additionally provided, which permeates the oil tank and is designed for conducting cooling air, in the diameter of which a fan is arranged, wherein the diameter of the second pipeline is greater that the diameter of the first pipelines.

The tank is preferably made of aluminum and can have a single hollow space or be divided into a plurality of chambers. According to a particularly embodiment, the oil tank has a chamber for stockpiling lubricating oil and/or a chamber for stockpiling hydraulic oil.

The pipelines are particularly designed as extruded profiles, wherein specifically the first pipelines can be designed to have inner ribs for a good heat transfer.

The base area of the pipelines can be designed so as to be circular but also triangular, square, hexagonal, or octagonal. For manufacturing the oil tank, the pipelines can be welded to the base and cover plate of the tank, which are provided with corresponding openings, wherein the openings of the pipelines which open into the surface can be designed as nozzles which facilitate the air intake or outlet.

The first pipelines are provided exclusively for cooling the oil stored in the oil tank. The second pipeline, the diameter of which is preferably multiple times greater than the diameter of the first pipelines, is used to conduct cooling air through the oil tank without the cooling capacity of the conducted air being depleted, and can be used for cooling particularly the generator.

According to the invention, a fan is arranged in the diameter of the second pipeline for controlling the airflow flowing through the second pipeline. The fan is speed-controlled particularly on the basis of the temperature of the generator, and so the cooling capacity can be adjusted to the power loss of the generator. The speed control can be steplessly adjustable or designed as a step switch.

According to a particularly preferred embodiment, the drive motor of the fan is a hydraulic motor, resulting in a synergistic effect from the oil tank storing hydraulic oil and the device for air-cooling the generator.

If the second pipeline is used in its function rather as a bypass, i.e. the cooling capacity is possibly not supposed to be reduced, when conducted through the second pipeline, the wall of the second pipeline can be designed so as to be thicker than the walls of the first pipelines, or the inner wall of the second pipeline can be coated or lined in a heat-insulating manner.

In order to be able to basically ensure both a cooling airflow guided through the first pipelines and the second pipeline, the passage surface of all first pipelines corresponds approximately to the passage surface of the second pipeline.

Finally, it is preferably provided that the first pipelines and the second pipeline are arranged parallel to one another, and so the manufacture of the oil tank according to the invention is particularly simple.

In order to ensure that the air guided through the oil tank is not exclusively guided through the (large-bore) second pipeline, a connection of the oil tank to two at least to some extent separate airflow circuits will in most cases be required. As a result, one airflow circuit is communicatingly connected to the first pipelines, and the other airflow circuit is communicatingly connected to the second pipeline.

Furthermore, a wind energy system with an air-cooled oil tank is provided, wherein the air-cooled oil tank has a multiplicity of first pipelines, which permeate the oil tank and are designed for conducting cooling air, having an essentially identical diameter, and a second pipeline, which permeates the oil tank and is designed for conducting cooling air, the diameter of which is greater than the diameter of the first pipelines, wherein the first pipelines are communicatingly connected to a first cooling-air circuit, and the second pipeline is communicatingly connected to a second cooling-air circuit. The generator of the wind energy system is preferably arranged in the second cooling-air circuit.

It is thus possible to form two at least to some extent separate cooling circuits, wherein one cooling circuit is used for air-cooling the generator, and the other cooling circuit is used for air-cooling other components, for example, the transmission and/or the hydraulic power unit.

The ratio of the passage surface of all first pipelines to the passage surface of the second pipeline depends, according to their power loss, on the cooling demand of the components arranged in the first cooling circuit and/or the second cooling circuit. In particular, for the layout of the oil tank, it must be ensured that the ratio of oil quantity, filling level height, and cross-section surface of the first pipelines results in a sufficient cooling (i.e. a sufficient ΔT) of the oil.

If, according to a preferred embodiment, the oil tank has oil pumps, they are arranged relative to the return flow on opposite points of the oil tank in order to ensure that the heated oil, which flows back into the oil tank, travels as long a distance as possible between the pipelines and can be sufficiently cooled.

According to a preferred embodiment, the first cooling-air circuit and the second cooling-air circuit are designed so as to be closed, wherein the second cooling-air circuit merges with the first cooling-air circuit particularly preferably downstream of the generator. The design as a closed cooling-air circuit is advantageous because no cooling air that is contaminated and requires elaborate cleaning comes in contact with the components to be cooled which are arranged in the wind energy system.

For driving the first or second cooling circuit, further fans are provided in the cooling circuits in addition to a fan provided in the oil tank.

Alternatively to the fan preferably provided in the oil tank, a fan, e.g. the self-ventilation device of the generator, can be provided at a different location in the second cooling circuit for generating an air flow. In such case, a flap mechanism is provided in the second pipeline which can control the air quantity guided through the second pipeline. The flap position—similar to the power of the fan arranged in the oil tank—is preferably based on the temperature of the generator.

Basically, the air-cooled oil tank, installed in the wind energy system designed according to the invention, can be designed similar to the oil tank previously described as an independent product. In particular, a fan can thus be arranged in the diameter of the second pipeline. The drive motor of said fan is preferably a hydraulic motor.

Further preferably, the passage surface of all first pipelines corresponds to the passage surface of the second pipeline.

Specifically, the first pipelines of the oil tank of the wind energy system can also have inner ribs.

Finally, the first pipelines and the second pipeline are also preferably arranged in a parallel manner.

The air-cooled oil tank according to the invention is advantageous because the oil cooling required for the transmission and the air cooling required for the generator are realized in a compact unit. For cooling both the transmission and the generator, no water cooling system, no further heat exchanger, and also no complicated controller for controlling the cooling power is required.

In the following, the invention shall be described in more detail using an embodiment with a particularly preferable design shown in the attached drawings.

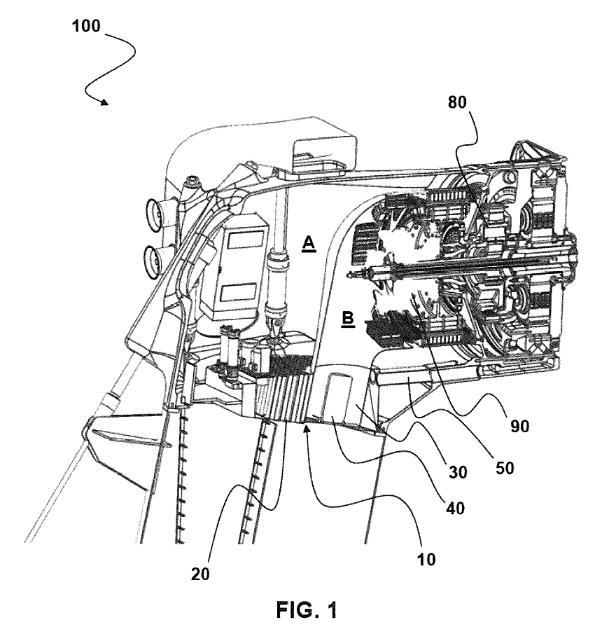

FIG. 1 shows a perspective cutaway view of a wind energy system designed according to the invention;

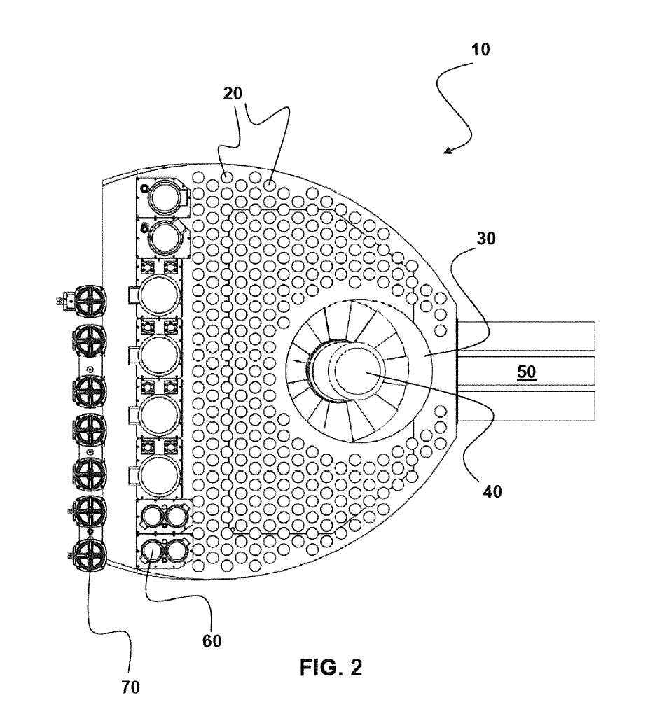

FIG. 2 shows a top view of the air-cooled oil tank according to the invention; and

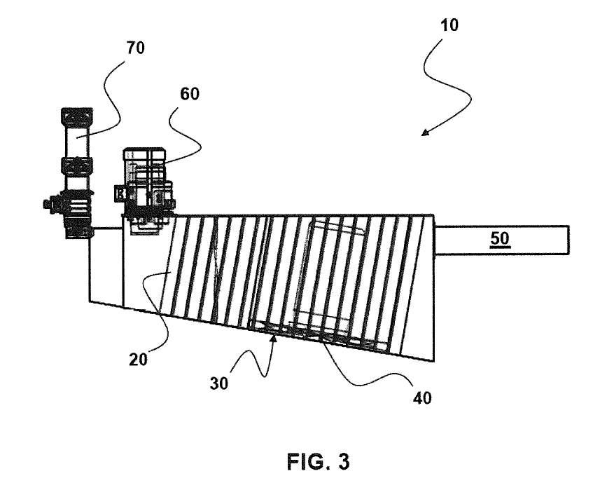

FIG. 3 shows a side view of the air-cooled oil tank.

FIG. 1 shows a perspective cutaway view of a section of a wind energy system designed according to the invention. The wind energy system 100 has—as is known—a tower and an enclosed energy converter arranged on the tower. The energy converter consists of a rotor mounted in a rotor bearing, a transmission 80, and a generator 90 (not depicted in detail).

In the depicted example, the air-cooled oil tank 10 is arranged between the tower and the end carriage of the wind energy system 100 and—with the exception of a closable manhole—occupies the entire tower diameter in the area of the end carriage. The upper side of the oil tank 10 forms a horizontal surface.

The oil tank 10 has a multiplicity of first pipelines 20 which permeate the oil tank 10 vertically, and a second pipeline 30. It can be clearly seen that the first pipelines 20 have a smaller diameter than the second pipeline 30. In the second pipeline 30, a fan 40 is arranged which is preferably speed-controlled on the basis of the temperature of the generator 90. The drive motor of the fan 40 can particularly preferably be designed as a hydraulic motor, and so the oil stored in the oil tank 10 can also be used for driving the fan 40.

In the interior of the end carriage of the wind energy system 100, a first cooling-air circuit A and a second cooling-air circuit B are formed. The first cooling-air circuit A is communicatingly connected to the multiplicity of the first pipelines 20 of the oil tank 10, while the second cooling-air circuit B is communicatingly connected mainly to the second pipeline 30.

Since the (air-cooled) generator 90 is preferably arranged in the second cooling-air circuit B, the generator 90 is preferably cooled on the basis of the power of the fan 40 arranged in the second pipeline 30.

In the embodiment shown in FIG. 1 with its particularly preferred design, the second cooling-air circuit B merges with the first cooling-air circuit downstream of the generator 90, whereupon the exhaust air is cooled in an air/air cooler arranged on the outside on the end carriage or on the tower and fed again to the underside of the oil tank 10.

FIG. 2 shows a top view of the air-cooled oil tank according to the invention. From this view, it becomes apparent that the oil tank 10 essentially extends in one plane, wherein the pipelines 20, 30 permeate the oil tank 10 from the bottom to the top, and the return flow 50 of the lubricating oil lines runs in the plane of the oil tank 10.

The multiplicity of the first pipelines 20 can be clearly seen, and the overall passage surface corresponds approximately to the passage surface of the second pipeline 30. On the left side of the drawing, oil pumps 60 and filter devices 70 for cleaning the oil are arranged. In particular, the oil pumps 60 are arranged in the oil tank 10 opposite of the return flow 50, and so the oil flowing back into the oil tank 10 is forcibly guided past the pipelines 20 and cooled. The side view of the air-cooled oil tank 10 from FIG. 3 shows that the arrangement of these means on the oil tank 10 has no interfering effect on the cooling of the oil.

In particular, it can be seen that the oil tank is designed in its cross-section as a rectangular trapezoid, wherein the pipelines 20, 30, which run obliquely to the upper surface of the oil tank 10, lead vertically to the lower surface of the oil tank 10.

1. An air-cooled oil tank comprising:
a multiplicity of first pipelines, which permeate the oil tank and are designed for conducting cooling air, having an essentially identical diameter, and
a second pipeline, which permeates the oil tank and is designed for conducting cooling air, in the diameter of which a fan is arranged, wherein the diameter of the second pipeline is greater that the diameter of the first pipelines.

2. The oil tank according to claim 1, characterized in that the drive motor of the fan is a hydraulic motor.

3. The oil tank of claim 1, characterized in that the passage surface of all first pipelines corresponds to the passage surface of the second pipeline.

4. The oil tank of claim 1, characterized in that the first pipelines have inner ribs.

5. The oil tank of claim 1, characterized in that the first pipelines and the second pipeline are arranged in a parallel manner.

6. A wind energy system with an air-cooled oil tank, characterized in that the air-cooled oil tank has
a multiplicity of first pipelines, which permeate the oil tank and are designed for conducting cooling air, having an essentially identical diameter, and
a second pipeline, which permeates the oil tank and is designed for conducting cooling air, the diameter of which is greater than the diameter of the first pipe lines, wherein the first pipelines are communicatingly connected to a first cooling-air circuit, and the second pipeline is communicatingly connected to a second cooling-air circuit.

7. The wind energy system according to claim 6, characterized in that the generator of the wind energy system is arranged in the second cooling-air circuit.

8. The wind energy system according to claim 6, characterized in that the first cooling-air circuit and the second cooling-air circuit are designed so as to be closed.

9. The wind energy system according to claim 6, characterized in that the second cooling-air circuit merges with the first cooling-air circuit downstream of the generator.

10. The wind energy system according to claim 7, characterized in that the first cooling-air circuit and the second cooling-air circuit are designed so as to be closed.

11. The wind energy system according to claim 7, characterized in that the second cooling-air circuit merges with the first cooling-air circuit downstream of the generator.

12. The wind energy system according to claim 8, characterized in that the second cooling-air circuit merges with the first cooling-air circuit downstream of the generator.

13. The oil tank of claim 2, characterized in that the passage surface of all first pipelines corresponds to the passage surface of the second pipeline.

14. The oil tank of claim 2, characterized in that the first pipelines have inner ribs.

15. The oil tank of claim 2, characterized in that the first pipelines and the second pipeline are arranged in a parallel manner.

16. The oil tank of claim 3, characterized in that the first pipelines have inner ribs.

17. The oil tank of claim 3, characterized in that the first pipelines and the second pipeline are arranged in a parallel manner.

18. The oil tank of claim 4, characterized in that the first pipelines and the second pipeline are arranged in a parallel manner.
